(19) United States
(12) Patent Application Publication
(10) Pub. No.: US 2014/0322961 A1
(43) Pub. Date: Oct. 30, 2014

(54) CONNECTOR ASSEMBLY

(71) Applicants: HON HAI PRECISION INDUSTRY CO., LTD., New Taipei (TW); Hong Fu Jin Precision Industry (ShenZhen) Co., Ltd, Shenzhen (CN)

(72) Inventors: YI-FANG WU, New Taipei (TW); KE CHEN, Shenzhen (CN); FOO SEE WOEI, Shenzhen (MY)

(73) Assignees: HON HAI PRECISION INDUSTRY CO., LTD., New Taipei (TW); Hong Fu Jin Precision Industry (ShenZhen) Co., Ltd, Shenzhen (CN)

(21) Appl. No.: 14/105,179

(22) Filed: Dec. 13, 2013

(30) Foreign Application Priority Data
Apr. 30, 2013 (CN) 2013101552601

(51) Int. Cl. H01R 13/58

(52) U.S. Cl. CPC H01R 13/5833
USPC 439/456

(57) ABSTRACT

A connector assembly includes a connector, and a protective cover. The connector includes a connecting body and two positioning structures integrated with the connecting body. Each of the two positioning structures defines a limiting slot and comprises two hooks. The protective cover for covering the connecting body includes two protecting walls and two latching blocks being located on each of the two protecting walls. Each of the two protecting walls is slidably engaged in the limiting slot of each of the two positioning structures, and the two hooks are engaged with the two latching blocks to prevent the latching strip from sliding out of the limiting slot.

### BACKGROUND

1. Technical Field

The present disclosure relates to connector assemblies, and more particularly to a connector assembly with a protective cover.

2. Description of Related Art

Connectors are widely used on printed circuit boards (PCBs) and cable assembly. A conventional connector includes an inserting portion and a plurality of connecting lines extending from the inserting portion. The plurality of connecting lines usually are exposed out of a connector enclosure, which may be dangerous.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an isometric, exploded view of an embodiment of a connector assembly, viewed from one aspect.

FIG. 2 is an assembled view of the connector assembly of FIG. 1.

FIG. 3 is a left side view of the connector assembly of FIG. 2.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

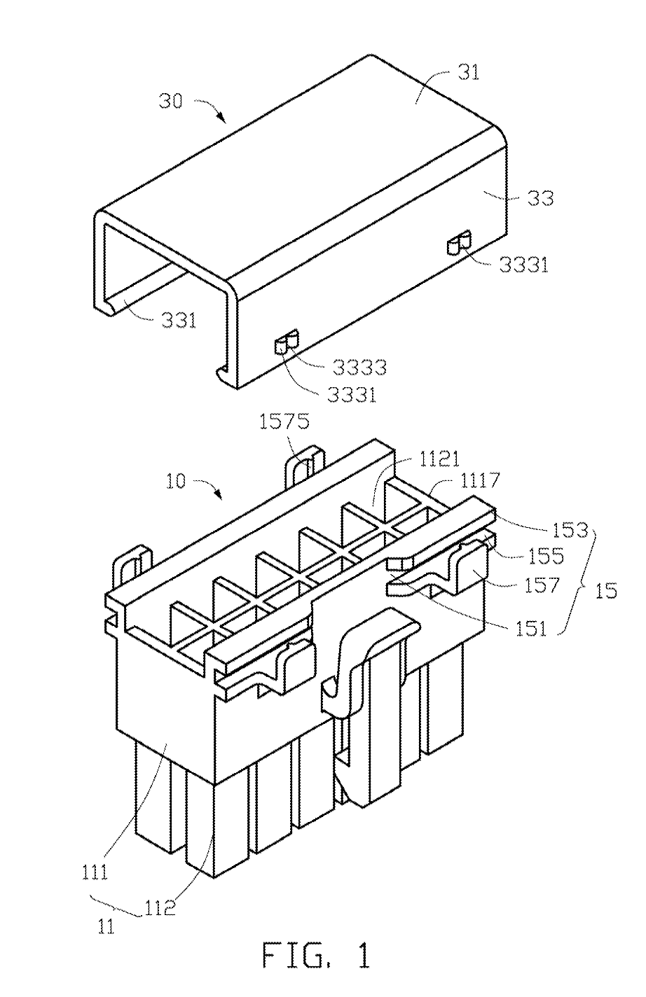

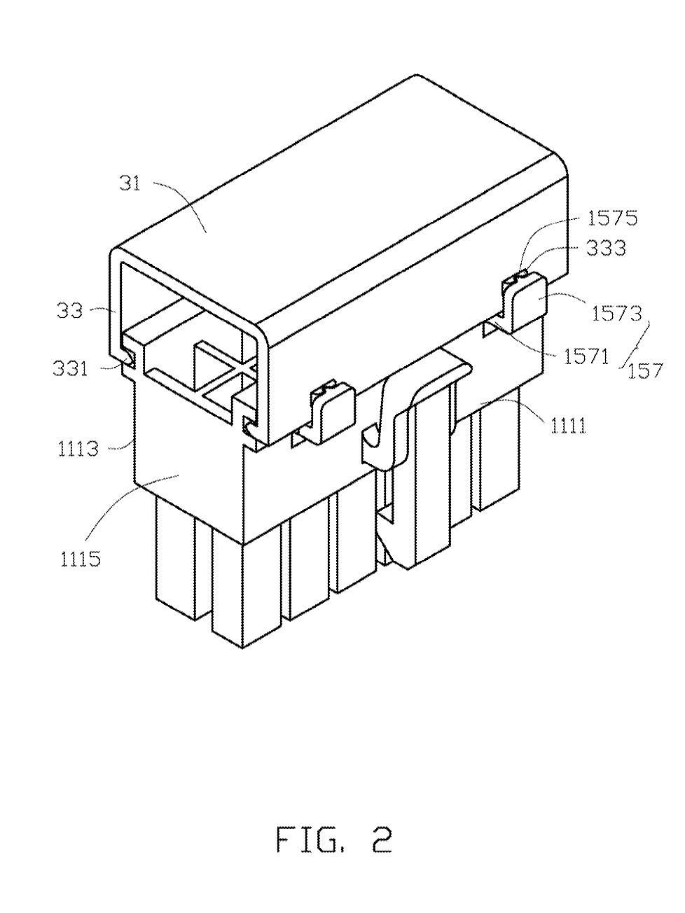

FIGS. 1 and 2 show a connector assembly in accordance with one embodiment. The connector assembly includes a connector 10 and a protective cover 30 mounted to the connector 10.

The connector 10 includes a connecting body 11 and two positioning structures 15 integrated with the connecting body 11. The connecting body 11 includes a mounting portion 111 and a plurality of inserting portions 112. The plurality of inserting portions 112 substantially perpendicularly extend from the mounting portion 111. Each of the plurality of inserting portions 112 defines a substantially rectangular accommodation hole 1121. The accommodation holes 1121 extend through the mounting portion 111, and each of the accommodation holes 1121 has an extension direction. A plurality of connecting lines (not shown) pass through the accommodation holes 1121. The mounting portion 111 includes a front wall 1111, a back wall 1113, a first sidewall 1115, and a second sidewall 1117 opposite to the first sidewall 1115. The first sidewall 1115 and the second sidewall 1117 are respectively perpendicularly connected to the front wall 1111 and the back wall 1113. The front wall 1111 is substantially parallel to the back wall 1113.

Each of the two positioning structures 15 includes a connecting wall 151, two top flanges 153, two bottom flange 155 opposite to the two flanges 153, and two hooks 157. Each connecting wall 151 extends upwards from each of the front wall 1111 and the back wall 1113. The two top flanges 153 horizontally extend outwards from a top edge of each connecting wall 151. The two bottom flanges 155 extend outwards from each of the front wall 1111 and the back wall 1113. The two top flanges 153, the two bottom flange 155, and the connecting wall 151 cooperatively define a limiting slot 1511. Each of the two hooks 157 includes a connecting tab 1571 and a resilient tab 1573. The connecting tab 1571 horizontally extends from corresponding bottom flange 155. The resilient tab 1573 substantially perpendicularly extends upwards from the connecting tab 1571. The resilient tab 1573 is parallel to the front wall 1111 and the back wall 1113. A rib 1575 is located on an inner surface of the resilient tab 1573 and has a semicircular cross-section.

The protective cover 30 includes a top wall 31 and two protecting walls 33. The two protecting walls 33 substantially perpendicularly extend downwards from opposite edges of the top wall 31. The two protecting walls 33 are substantially parallel to each other. A latching strip 331 extends inwards from a distal end of each of the two protecting walls 33. Two latching blocks 333 are located on each of the two protecting walls 33 and adjacent to corresponding latching strip 331. Each latching block 333 includes two protrusions 3331, and a latching slot 3333 is defined between the two protrusions 3331. Each protrusion 3331 has a semicircular cross-section.

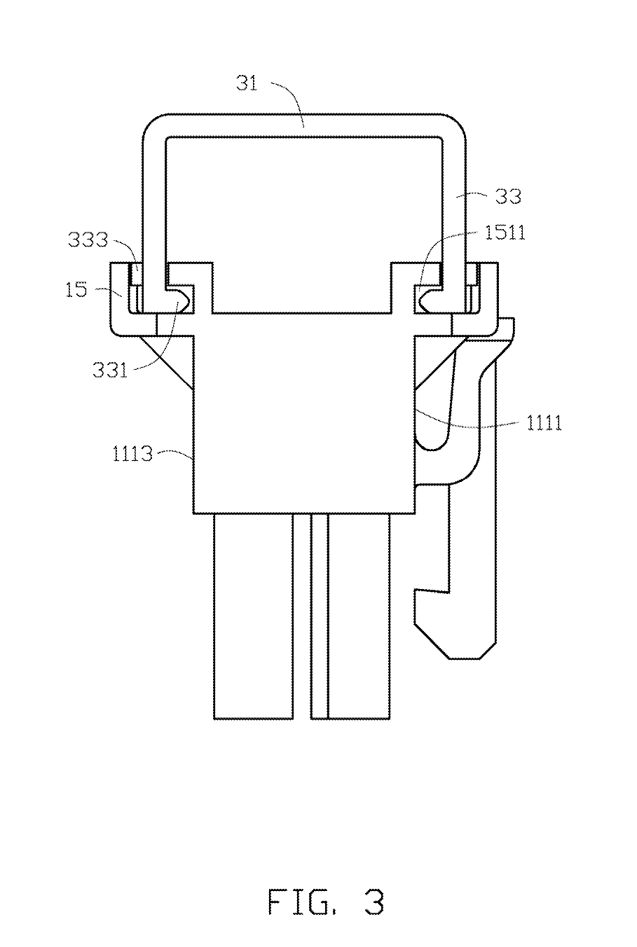

FIG. 3 shows that in use, the protective cover 30 is placed in one side of the connector 10. Each latching strip 331 is aligned with each limiting slot 1511 and inserted into the limiting slot 1511. The protective cover 30 is pushed along a first direction, and each latching block 333 squeezes each rib 1575 to deform corresponding resilient tabs 1573. The protective cover 30 is further pushed, until each rib 1575 is aligned with the each latching slot 3333, and each resilient tab 1573 resiliently rebounds to engage each rib 1575 in each latching slot 3333, to prevent the protective cover 30 from sliding out of the limiting slot 1511. Each latching strip 331 is received in each limiting slot 1511 to prevent the protective cover 30 from moving in a plane that is substantially perpendicular to the front wall 1111.

When the protective cover 30 is detached, the protective cover 30 is pushed along the first direction or a second direction opposite to the first direction, until each rib 1575 is disengaged from corresponding latching slot 3333. The protective cover 30 is thereby slid out of corresponding limiting slot 1511.

Even though numerous characteristics and advantages of the present disclosure have been set forth in the foregoing description, together with details of the structure and function of the disclosure, the disclosure is illustrative only, and changes may be made in detail, especially in the matters of shape, size, and the arrangement of parts within the principles of the disclosure to the full extent indicated by the broad general meaning of the terms in which the appended claims are expressed.

What is claimed is:

1. A connector assembly, comprising:
a connector comprising a connecting body and two positioning structures integrated with the connecting body, and each of the two positioning structures defining a limiting slot and comprising two hooks; and
a protective cover for covering the connecting body and comprising two protecting walls and two latching blocks being located on each of the two protecting walls,
wherein each of the two protecting walls is slidably engaged in the limiting slot of each of the two positioning structures, and the two hooks are engaged with the two latching blocks to prevent the protective cover from sliding out of the limiting slot.

2. The connector assembly of claim 1, wherein a rib is located on each of the two hooks, each of the two latching blocks defines a latching slot, and the rib is engaged in the latching slot; and each of the hooks is resiliently deformable to disengage the rib from the latching slot.

3. The connector assembly of claim 1, wherein a latching strip extends from each of the two protecting walls, and the latching strip is engaged in the limiting slot.

4. The connector assembly of claim 2, wherein each of the two positioning structures further comprises a connecting wall, two top flanges located on the connecting wall, and two bottom flanges located on the connecting body; and the connecting wall, the two top flanges, and the bottom flanges cooperatively define the limiting slot.

5. The connector assembly of claim 4, wherein the connecting body comprising a front wall and a back wall parallel to the front wall; each connecting wall horizontally extends from each of the front wall and the back wall, the two top flanges extend from a top edge of each connecting wall, and the two bottom flanges extend from each of the front wall and the back wall.

6. The connector assembly of claim 5, wherein each of the two top flanges is substantially parallel to each of the two bottom flanges.

7. The connector assembly of claim 5, wherein each of the hooks includes a connecting tab and a resilient tab, each connecting tab extends from each of the two bottom flanges, and the resilient tab extends from the connecting tab, and the rib is located in the connecting tab.

8. The connector assembly of claim 7, wherein the resilient tab is parallel to the front wall and the back wall.

9. The connector assembly of claim 1, wherein the rib has a semicircular cross-section.

10. The connector assembly of claim 1, wherein the protective cover further comprises a top wall connected to the two protective cover, and the two protective cover are parallel to each other and substantially perpendicular to the top wall.

11. A connector assembly, comprising:
a connector comprising a connecting body and two positioning structures, the connecting body comprising a front wall and a back wall opposite to the front wall, and each of the two positioning structures being integrated with each of the front wall and the back wall and defining a limiting slot and comprising two hooks; and
a protective cover for covering the connecting body and comprising two protecting walls and two latching blocks being located on each of the two protecting walls,
wherein each of the two protecting walls is slidably engaged in the limiting slot of each of the two positioning structures to prevent the protective cover form moving along a plane that is substantially perpendicular to the front wall and the back wall, and the two hooks are engaged with the two latching blocks to prevent the protective cover from moving along a direction that is substantially perpendicular to the plane.

12. The connector assembly of claim 11, wherein a rib is located on each of the two hooks, each of the two latching blocks defines a latching slot, and the rib is engaged in the latching slot; and each of the hooks is resiliently deformable to disengage the rib from the latching slot.

13. The connector assembly of claim 11, wherein a latching strip extends from each of the two protecting walls, and the latching strip is engaged in the limiting slot.

14. The connector assembly of claim 12, wherein each of the two positioning structures further comprises a connecting wall, two top flanges located on the connecting wall, and two bottom flanges located on the connecting body; and the connecting wall, the two top flanges, and the bottom flanges cooperatively define the limiting slot.

15. The connector assembly of claim 14, wherein each connecting wall horizontally extends from each of the front wall and the back wall, the two top flanges extend from a top edge of each connecting wall; and the two bottom flanges extend from each of the front wall and the back wall.

16. The connector assembly of claim 15, wherein each of the two top flanges is substantially parallel to each of the two bottom flanges.

17. The connector assembly of claim 14, wherein each of the hooks includes a connecting tab and a resilient tab, each connecting tab extends from each of the two bottom flanges, and the resilient tab extends from the connecting tab, and the rib is located in the connecting tab.

18. The connector assembly of claim 17, wherein the resilient tab is parallel to the front wall and the back wall.

19. The connector assembly of claim 11, wherein the rib has a semicircular cross-section.

20. The connector assembly of claim 11, wherein the protective cover further comprises a top wall connected to the two protective cover, and the two protective cover are parallel to each other and substantially perpendicular to the top wall.
